(19) United States
(12) Patent Application Publication
(10) Pub. No.: US 2020/0215472 A1
(43) Pub. Date: Jul. 9, 2020

(54) Reservoir Inlet Air Cleaning System

(71) Applicant: Robert K. Foerster, Carson City, NV (US)

(72) Inventor: Robert K. Foerster, Carson City, NV (US)

(21) Appl. No.: 16/241,928

(22) Filed: Jan. 7, 2019

(51) Int. Cl. B01D 46/00

(52) U.S. Cl. CPC B01D 46/0012; B01D 46/0017; B01D 46/0047; B01D 46/0041; B01D 46/0087

(57) ABSTRACT

When drawing down drinking water stored in an enclosed reservoir, air must be utilized to displace the drawn-down drinking water in order to ensure an acceptable level of drinking water outflow. If the intake air is not clean, or if debris is carried by the intake air into the reservoir tank, contamination of the drinking water may commence. Such contamination or build-up of unwanted particulates is obviously not desirable. The reservoir inlet air cleaning system serves to prevent potentially contaminating materials carried by the atmosphere from entering the reservoir tank. The system is scalable to reservoirs of all sizes, and thus may be customized for a particular use or for a particular location. An exemplary embodiment of the reservoir inlet air cleaning system may include a filtration unit, an air conduit, a means for controlling air intake so that other potential points of air inlet are closed off, means for controlling both condensate accumulation and contamination in the air conduit (and the reservoir tank), and means for preventing partial vacuum conditions and over-pressure conditions within the reservoir tank (or the air conduit) so as to avoid damage that may be caused by partial vacuum conditions and over-pressure conditions.

### BRIEF DESCRIPTION OF THE INVENTION

The present invention is generally related to water storage, and more particularly related to a system for cleaning the intake air that is used to displace water that has been stored in a storage container such as a water reservoir tank. Such a reservoir inlet air cleaning system may include a filtration unit, an air conduit, a means for controlling air intake so that other potential points of air inlet are closed off, means for controlling both condensate accumulation and contamination in the air conduit (and the reservoir tank), and means for preventing partial vacuum conditions and over-pressure conditions within the reservoir tank (or the air conduit) so as to avoid damage that may be caused by partial vacuum conditions and over-pressure conditions.

The herein disclosed reservoir inlet air cleaning system serves to prevent potentially contaminating materials carried by the atmosphere from entering the reservoir tank. The system is scalable to reservoirs of all sizes, and thus may be customized for a particular use or for a particular location. In a preferred embodiment, the reservoir inlet air cleaning system is sized to allow unimpeded air flow volume corresponding to the maximum anticipated reservoir drawdown (during a fire while fire prevention personnel are actively utilizing reservoir tank water to fight a fire, for example), but not during unusual catastrophic failure events (such as structural failure caused by an earthquake, for example). Where large volumes of air are required to displace large flows of reservoir water, multiple filtration units may be utilized in parallel within a reservoir inlet air cleaning system. Alternatively, at locations where multiple reservoir tanks are positioned in close proximity, a single inlet air cleaning system (having one or more filtration units) may be employed, sized to accommodate air for all of the reservoir tanks simultaneously.

A preferred embodiment of the present invention comprises: a filtration unit for screening, pre-filtering, and filtering intake air; a self-closing value for preventing ambient air from entering a reservoir tank; an air intake transfer conduit for directing intake air from the filtration unit to the reservoir tank, wherein the air conduit includes one or more vacuum relief safety inlets for preventing a partial vacuum condition; and an air outlet transfer conduit for directing overflow air out of the reservoir inlet air cleaning system, wherein the air outlet transfer conduit includes a condensation drain check value, a pressure relief safety outlet, a one-way backdraft dampener device for preventing ambient air from entering through the air outlet transfer conduit, and a screen for preventing entry of debris through the air outlet transfer conduit.

### CROSS-REFERENCES TO RELATED APPLICATIONS

No applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK.

Not applicable.

### BACKGROUND OF THE INVENTION

After drinking water is filtered and/or decontaminated and therefore ready for human consumption, but before the drinking water arrives at a tap, drinking water normally spends a significant length of time being stored in a drinking water reservoir. Such drinking water reservoirs may be configured as a tank, a stand pipe, an elevated storage facility, a backwash water tank, a hydropneumatic tank, or an alternative enclosure.

To drawdown the drinking water stored in such enclosed reservoirs, air must be utilized to displace the drawn down drinking water in order to ensure an acceptable level of outflow of drinking water. This air may be referred to as intake air, or reservoir intake air, referring to the fact that this air enters the reservoir tank at an air inlet. If the intake air is not clean, or if debris (such as particulates like dust, pollen, smoke [and other particulate matter arising from various forms of combustion] mold spores, fungal spores, cysts, insects, and/or insect parts) is carried by the intake air into the reservoir tank, contamination of the drinking water may commence. Such contamination or build-up of unwanted particulates is obviously not desirable.

It would therefore be advantageous to provide a means for preventing the entry of particulates by screening and/or filtering the intake air entering a reservoir tank. The herein disclosed reservoir inlet air cleaning system may be utilized with a reservoir tank to prevent, or minimize, material carried by the atmosphere from entering the reservoir. In this way, the need for frequent reservoir cleaning may be obviated and water quality may be maintained at an improved level throughout every stage of a region's drinking water delivery system. Furthermore, keeping drinking water clean throughout the delivery system sends a positive message about public water system and thus can boost the public relations efforts of public and private utilities.

### BRIEF DESCRIPTION OF THE SEVERAL VIEWS OF THE DRAWING

FIG. 1 illustrates a general overview of the herein disclosed reservoir inlet air cleaning system utilized with a water reservoir tank, in accordance with a preferred embodiment of the present invention;

FIG. 2 illustrates a detailed view of the herein disclosed reservoir inlet air cleaning system utilized with a water reservoir tank, in accordance with a preferred embodiment of the present invention;

FIG. 3 illustrates a detailed view of an air outlet transfer conduit, a component of the herein disclosed reservoir inlet air cleaning system, in accordance with a preferred embodiment of the present invention; and

FIG. 4 illustrates a detailed view of a condensation drain with a check valve, a component of the herein disclosed reservoir inlet air cleaning system, in accordance with a preferred embodiment of the present invention.

### DETAILED DESCRIPTION OF THE INVENTION

The present invention is generally related to water storage, and more particularly related to a system for cleaning the intake air that is used to displace water that has been stored in a storage container such as a water reservoir tank. An exemplary embodiment of such a reservoir inlet air cleaning system may include a filtration unit, an air conduit, a means for controlling air intake so that other potential points of air inlet are closed off, means for controlling both condensate accumulation and contamination in the air conduit (and the reservoir tank), and means for preventing partial vacuum conditions and over-pressure conditions within the reservoir tank (or the air conduits) so as to avoid damage that may be caused by partial vacuum conditions and over-pressure conditions.

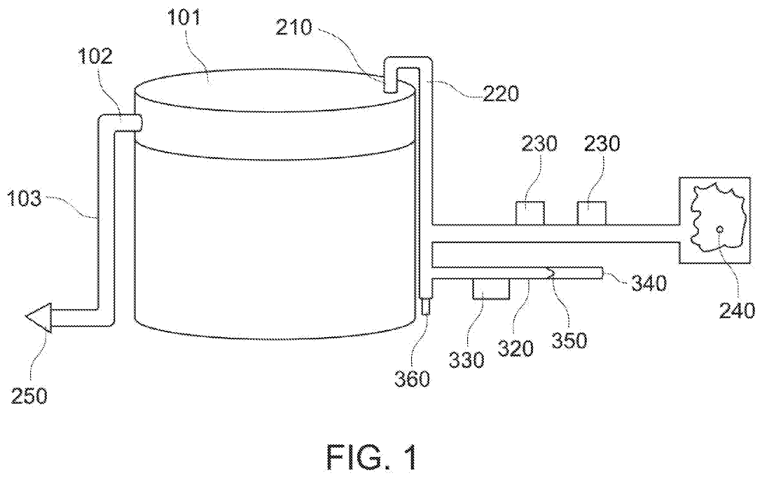

Throughout this specification (and as illustrated in FIG. 1), the herein disclosed reservoir inlet air cleaning system is mostly described as being used in combination with a reservoir tank. Those skilled in the art will recognize that the reservoir inlet air cleaning system may be advantageously utilized in combination with alternative types of water storage containers, facilities, or systems, including a stand pipe, a tank, an elevated storage facility, a backwash water tank, a hydropneumatic tank, or an alternative enclosure, and all such types of water storage containers, facilities, or systems are intended to be included herein. The reservoir inlet air cleaning system may additionally be utilized in water production wells wherein air enters the well casing as water is displaced during pumping, as well as in vacuum relief devices for pipelines that allow entry of air during formation of partial vacuum conditions.

Furthermore, this specification will mostly refer to the liquid to be stored in the reservoir (or alternative container, facility, or system) as water. But those skilled in the art will recognize that the herein disclosed reservoir inlet air cleaning system may be utilized in combination with containers, facilities, or systems for storing liquids other than water, and all such liquids are intended to be included herein.

Referring to FIG. 1, reservoir tank 101 includes existing water overflow outlet 102 and air transfer conduit opening 210. Reservoir tank 101 may be any type of water storage reservoir; an enclosed reservoir tank is illustrated in FIG. 1 as an exemplary embodiment, but those skilled in the art will recognize that the reservoir inlet air cleaning system disclosed herein may be utilized in combination with alternative types of liquid storage containers, facilities, or systems. Existing water overflow outlet 102 is already present in most water storage reservoirs and is positioned above the predetermined maximum safe water level for reservoir tank 101. When the water level of reservoir tank 101 rises above the predetermined maximum safe water level, overflow water flows through existing water overflow outlet 102, through water overflow pipe 103, and out through check valve 250. Check valve 250 may be any type of valve or seal that can allow for flow of overflow water out of reservoir tank 101 while preventing water (or air or contaminants) from entering reservoir tank 101 from the outside through check valve 250; in an alternative embodiment, check valve 250 may be a duckbill seal or alternative means for preventing entry of unwanted water/air/contaminant.

Many existing reservoir tanks may include an existing water overflow outlet 102 and water overflow pipe 103 but may fail to include check valve 250. If a reservoir inlet air cleaning system is installed on such an existing reservoir tank, it is preferable to install check valve 250 (which may be an alternative means of preventing entry of unwanted water/air/contaminants) as part of the installation of reservoir inlet air cleaning system. Without securing the outlet of water overflow pipe 103, reservoir tank 101 is in constant danger of entry of unfiltered and therefore unwanted water/air/contaminants through water overflow pipe 103.

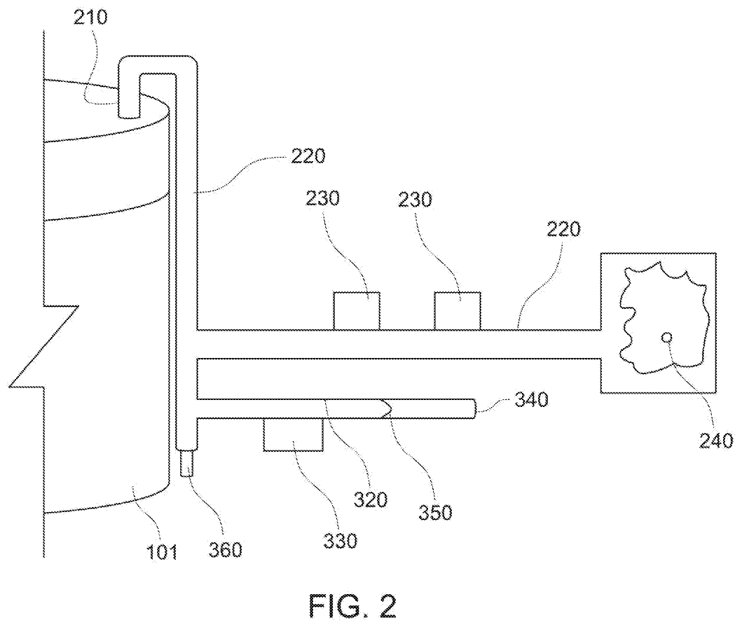

Referring to FIG. 2, a detailed view of an exemplary embodiment of a reservoir inlet air cleaning system is shown. Intake air enters the reservoir inlet air cleaning system at filtration unit 240 and is directed by air intake transfer conduit 220 to air transfer conduit opening 210 which opens into reservoir tank 101.

Filtration unit 240 may include any combination of screens and/or filters configured to screen and filter the intake air entering filtration unit 240. In a preferred embodiment, filtration unit 240 includes a fine screen and a pre-filter to remove gross or relatively large material, and an air filter whose maximum pore size is selected to correspond to particulate matter known to exist in the local ambient atmosphere. In the vast majority of locations, a preferred maximum pore size for the air filter of filtration unit 240 is one micron or less. A non-exhaustive list of particulates to consider when determining maximum pore size includes dust, pollen, smoke (and particulate matter arising from any form of combustion), mold and fungal spores, cysts, insects, and insect parts.

One or more vacuum relief safety inlets 230 may be formed by air intake transfer conduit 220. In a preferred embodiment (and as illustrated in the various figures), the herein disclosed reservoir inlet air cleaning system includes two vacuum relief safety inlets 230 positioned on (or formed through) air intake transfer conduit 220 at a location downstream from filtration unit 240. Vacuum relief safety inlets 230 open when air in air intake transfer conduit reaches a designated or predetermined minimum air pressure. A vacuum relief safety inlet is closed in normal conditions and only opens during minimum low pressure events. Such a low pressure event can occur if an air filter is not maintained or becomes suddenly blocked. Those skilled in the art will recognize that any number of vacuum relief safety inlets 230 may be utilized advantageously depending on local conditions and the required intake air flow volume, and all such configurations are intended to be included herein. Those skilled in the art will also recognize that vacuum relief safety inlets 230 may be formed or placed at any position along air intake transfer conduit. In a preferred embodiment, each vacuum relief safety inlet 230 is screened with a non-corroding material having a mesh opening of between 0.77 millimeters and 0.78 millimeters.

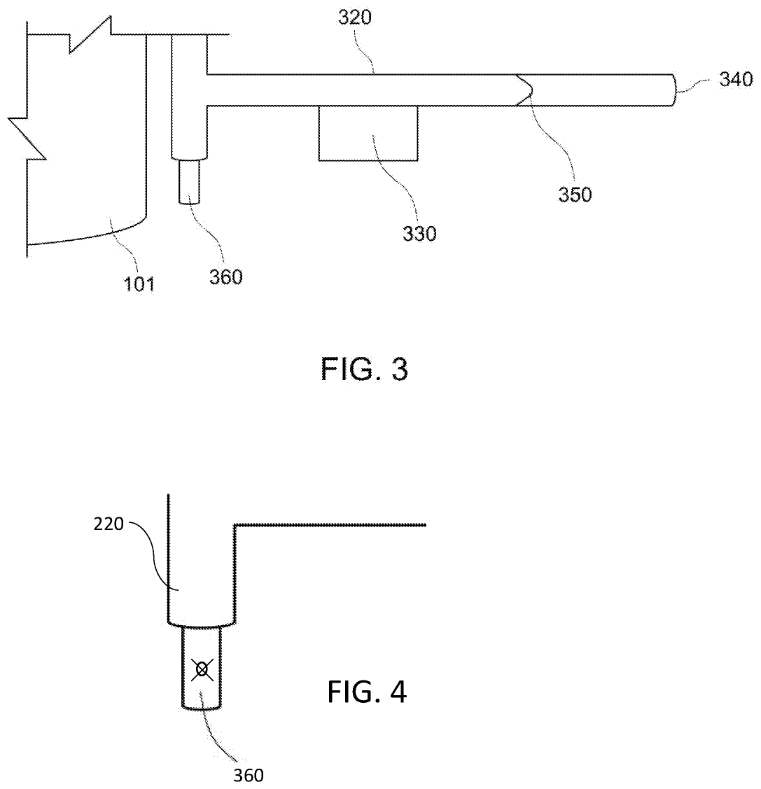

Referring to FIG. 3, a detailed view of air outlet transfer conduit 320 is shown having screen 340 at its distal end for preventing entry of debris through air outlet transfer conduit 320. Backdraft dampener device 350 may be positioned within air outlet transfer conduit 320 to prevent or restrict ambient air from entering through air outlet transfer conduit 320. In a preferred embodiment, dampener device 350 is a one-way backdraft prevention dampener device. Backdraft dampener device 350 may, in certain embodiments, be powered through an auxiliary power supply.

The reservoir tank and accompanying reservoir inlet air cleaning system is protected from over-pressure by means of one or more pressure relief safety outlet(s) 330 that open when air pressure at the location of the one or more pressure relief safety outlets reaches a designated or predetermined maximum air pressure. The one or more pressure relief safety outlets 330 are closed in normal conditions and only open during maximum high pressure events. Such high pressure events (or over-pressure events) will occur if a transfer conduit becomes blocked, which may happen if backdraft dampener device 350 fails or the system becomes blocked by ice accumulation.

Referring to FIG. 4, a detailed view of condensation check valve 360 is shown positioned at a lowest point (or alternatively, at a relatively low point) of air intake transfer conduit 220 so as to allow condensation to be removed from air intake transfer conduit 220 (and, depending on the configuration, possibly from air outlet transfer conduit 320) via gravity flow through check valve 360.

The herein disclosed reservoir inlet air cleaning system can be scaled to reservoirs of all sizes, and thus may be customized for a particular use or for a particular location. In a preferred embodiment, the reservoir inlet air cleaning system is sized to allow an unimpeded air flow volume corresponding to the maximum anticipated reservoir drawdown (during a fire while fire prevention personnel are actively utilizing reservoir tank water to fight the fire, for example), but not during unusual catastrophic failure events (such as structural failure caused by an earthquake, for example). At locations where large volumes of air are required to displace large flows of reservoir water, multiple filtration units may be utilized in parallel within a reservoir inlet air cleaning system. For example, a first filtration unit may be arranged in parallel with a second filtration unit so as to provide a greater volume of intake air for the reservoir tank. In another example, a third filtration unit for filtering intake air may be incorporated in parallel with a first filtration unit and a second filtration unit so as to provide an even greater volume of intake air for the reservoir tank. Alternatively, at locations where multiple reservoir tanks are positioned in close proximity, a single inlet air cleaning system (having one or more filtration units) may be employed; such an arrangement would require air transfer conduits sized to accommodate air for all of the reservoir tanks simultaneously.

Those skilled in the art will recognize that the herein disclosed reservoir inlet air cleaning system may be formed with the disclosed components in a variety of differing arrangements without deviating from the intended purpose of preventing contaminants and debris from entering a reservoir tank through an air inlet. All such differing arrangements are intended to be included herein. For example, air intake transfer conduit 220 and air outlet transfer conduit 320 may be functionally combined into a single conduit. Such a single conduit arrangement may incorporate vacuum relief inlets 230, condensation drain check valve 360, pressure relief safety outlet 330, backdraft dampener device 350, and screen 340, and is intended to be included herein.

Those skilled in the art will also recognize that the herein disclosed reservoir inlet air cleaning system may be monitored during operation to determine performance and to facilitate optimization of performance in varying conditions. For example, differential pressure measuring equipment may be utilized to monitor performance during operation.

The herein disclosed reservoir inlet air cleaning system may be configured in a powered mode in certain embodiments. For example, backdraft dampener device 350, one or more vacuum relief safety inlets 230, and pressure relief safety outlets 330 may each be powered and actuated by an auxiliary power source. In such a powered mode, each of the components of the system can be outfitted with one or more sensors appropriate for the respective component that are communicatively connected to a monitoring and alarm system. In this way, performance can be monitored and the various safety systems can be actuated if necessary in an automated manor and/or with human intervention. Alternatively, the entire reservoir inlet air cleaning system can be configured in a mechanical mode with no auxiliary powered components.

To further prevent failures, the various components and conduits can be insulated and/or heated to prevent or protect against freezing conditions. For example, filtration unit 240 and/or portions of air intake transfer conduit 220 can be placed within a protective housing or structure. Such a housing or structure can be insulated and/or heated to protect against freezing conditions. Throughout this specification and the related claims, it is to be understood that the benefits derived from insulating the various components and conduits may alternatively be achieved through heating the same components and conduits. Those skilled in the art, therefore, will recognize that heating the various components and conduits is intended to be included herein as an alternative means of preventing or protecting against freezing conditions. The housing or structure can also be secured to prevent unauthorized entry and therefore prevent intentional contamination of the reservoir tank.

While the present invention has been illustrated and described herein in terms of a preferred embodiment and several alternatives, it is to be understood that the systems and devices described herein can have a multitude of additional uses and applications. Accordingly, the invention should not be limited to just the particular description and various drawing figures contained in this specification that merely illustrate a preferred embodiment and application of the principles of the invention.

What is claimed is:

1. A reservoir inlet air cleaning system, comprising:
a filtration unit for screening, pre-filtering, and filtering intake air;
a self-closing value for preventing ambient air from entering a reservoir tank, wherein the self-closing value is positioned at a water overflow outlet of the reservoir tank;
an air intake transfer conduit for directing intake air from the filtration unit to the reservoir tank, wherein the air conduit includes one or more vacuum relief safety inlets for preventing a partial vacuum condition; and
an air outlet transfer conduit for directing overflow air out of the reservoir inlet air cleaning system, wherein the air outlet transfer conduit includes a pressure relief safety outlet, a one-way backdraft dampener device for preventing ambient air from entering through the air outlet transfer conduit, and a screen for preventing entry of debris through the air outlet transfer conduit.

2. The reservoir inlet air cleaning system as recited in claim 1, further comprising a one-way check valve for removing condensation by gravity flow.

3. The reservoir inlet air cleaning system as recited in claim 1, wherein the filtration unit, the air intake transfer conduit, and the air outlet transfer conduit are insulated to protect against freezing conditions.

4. The reservoir inlet air cleaning system as recited in claim 1, wherein the filtration unit is housed in an insulated structure to prevent ice buildup.

5. The reservoir inlet air cleaning system as recited in claim 1, wherein the filtration unit is housed in a secure structure to prevent intentional contamination.

6. The reservoir inlet air cleaning system as recited in claim 1, wherein the filtration unit and the air outlet transfer conduit are at least partially housed in an insulated and secure structure to prevent ice buildup and intentional contamination.

7. The reservoir inlet air cleaning system as recited in claim 1, wherein the one or more vacuum relief safety inlets are screened with a non-corroding material having a mesh opening between 0.77 millimeters and 0.78 millimeters.

8. The reservoir inlet air cleaning system as recited in claim 1, further comprising a second filtration unit for filtering intake air, wherein the second filtration unit is in parallel with the filtration unit so as to provide a greater volume of intake air for the reservoir tank.

9. The reservoir inlet air cleaning system as recited in claim 8, further comprising a third filtration unit for filtering intake air, wherein the third filtration unit is in parallel with the second filtration unit and the filtration unit so as to provide a greater volume of intake air for the reservoir tank.

10. The reservoir inlet air cleaning system as recited in claim 1, wherein the air intake transfer conduit and the air outlet transfer conduit are functionally combined in a single conduit.

11. The reservoir inlet air cleaning system as recited in claim 1, wherein the one-way backdraft dampener device, the one or more vacuum relief safety inlets, and the pressure relief safety outlet are actuated by auxiliary power.

12. The reservoir inlet air cleaning system as recited in claim 11, wherein the one-way backdraft dampener device, the one or more vacuum relief safety inlets, and the pressure relief safety outlet are fitted with one or more sensors communicatively connected to a monitoring and alarm system.

13. A reservoir inlet air cleaning system for a reservoir tank, comprising:
a filtration unit for filtering intake air;
an air intake transfer conduit for directing intake air from the filtration unit to the reservoir tank, wherein the air conduit includes one or more vacuum relief safety inlets for preventing a partial vacuum condition; and
an air outlet transfer conduit for directing overflow air out of the reservoir inlet air cleaning system, wherein the air outlet transfer conduit includes a condensation drain check value, a pressure relief safety outlet, a one-way backdraft dampener device for preventing ambient air from entering through the air outlet transfer conduit, and a screen for preventing entry of debris through the air outlet transfer conduit

14. The reservoir inlet air cleaning system for a reservoir tank as recited in claim 13, wherein the filtration unit, the air intake transfer conduit, and the air outlet transfer conduit are insulated to protect against freezing conditions.

15. The reservoir inlet air cleaning system for a reservoir tank as recited in claim 13, wherein the filtration unit and the air outlet transfer conduit are at least partially housed in an insulated and secure structure to prevent ice buildup and intentional contamination.

16. The reservoir inlet air cleaning system for a reservoir tank as recited in claim 13, wherein the one or more vacuum relief safety inlets are screened with a non-corroding material having a mesh opening between 0.77 millimeters and 0.78 millimeters.

17. The reservoir inlet air cleaning system for a reservoir tank as recited in claim 13, further comprising a second filtration unit for filtering intake air, wherein the second filtration unit is in parallel with the filtration unit so as to provide a greater volume of intake air for the reservoir tank.

18. The reservoir inlet air cleaning system for a reservoir tank as recited in claim 13, wherein the air intake transfer conduit and the air outlet transfer conduit are functionally combined in a single conduit.

19. A reservoir inlet air cleaning system for a reservoir tank, comprising:
a filtration unit for filtering intake air;
an air conduit for directing intake air from the filtration unit to the reservoir tank;
means for preventing ambient air from entering the reservoir tank through a water overflow outlet;
means for preventing ambient air from entering the reservoir tank through additional openings formed by the reservoir tank;
means for minimizing condensate accumulation; and
means for preventing partial vacuum conditions.

20. The reservoir inlet air cleaning system for a reservoir tank as recited in claim 19, further comprising means for relieving over-pressure.
